(19) United States
(12) Patent Application Publication
(10) Pub. No.: US 2011/0044067 A1
(43) Pub. Date: Feb. 24, 2011

(54) Vehicle Auxiliary Light Assembly with Lined-Up LED's

(76) Inventor: KENG-CHIN YEH, Taipei City (TW)

Correspondence Address: Dr. BANGER SHIA;Patent Office of Bang Shia, 102 Lindencrest Ct, Sugar Land, TX, 77479-5201, US

(21) Appl. No.: 12/543,390

(22) Filed: Aug. 18, 2009

(51) Int. Cl. F21S 8/10

(52) U.S. Cl. 362/545

(57) ABSTRACT

An auxiliary or small light assembly with a series of lined-up LCD's fixed to a series of fixing boards is provided. The auxiliary light module is snapped into the big light assembly at the rear thereof, including a seat for a plurality of LCD's to be fixed to; a horizontal supporting piece extends from one side of the seat, including a plurality of hollow cylinders and a plurality of L-shape defenders extending vertically downwards from one side of each of hollow cylinders. A screwing element fixes each fixing board to a corresponding hollow cylinder of the auxiliary light assembly seat to forma a light assembly easy for maintenance.

### FIELD OF THE INVENTION

This invention relates to a vehicle auxiliary light Assembly with lined-Up LED's, in particular, to a vehicle auxiliary light module which is turned on before the main light is, has a seat for a plurality of LCD's, and is snapped into the main light assembly, saving trouble in replacing broken LCD's.

### DESCRIPTION OF PRIOR ART

Different varies of main light modules and auxiliary light modules are seen in vehicles. However, most of the auxiliary light modules are disposed in front of the main light modules for auxiliary light modules to turned on before main light modules. A disadvantage with the auxiliary light modules being disposed in front of main light modules is that the main light cover for main light module has to be taken off first when fixing a broken light in the auxiliary light module. The current invention is provided to overcome this inconvenience in traditional prior art.

### SUMMARY OF THE INVENTION

The current invention provides a brand-new orientation in the small light assembly body, which comprises a plurality of LED's disposed in the seat and is snapped into the big light assembly body at the rear thereof, facilitating replacement for burned-out LCD's.

This invention is motivated by the idea of having a small light assembly body as an independent module before assembling with the big light assembly body for easy of maintenance.

The small light assembly body includes a light seat for a plurality of LCD's to be seriously disposed. The seat further includes a horizontal supporting piece extending from one side of the small light assembly seat. A plurality of hollow cylinders, and a plurality defenders are disposed over the light seat.

Preferably, each of defenders is in an L-shape, which extends vertically downwards along one side of a hollow cylinder to partially confine the fixing board.

Preferably, each of said plurality of LCD's is connected in series by electric wires.

### BRIEF DESCRIPTION OF DRAWINGS

FIG. 1 is a rear perspective view of the small light assembly body before snapping into the big light assembly body.

FIG. 2 is an exploded perspective view of the small light assembly body.

FIG. 3 is a another perspective view of the small light assembly body.

FIG. 4 is a bird's-eye view of the small light assembly body.

FIG. 5 is a perspective view of the small light assembly body after snapping into the big light assembly body.

FIG. 6 illustrates the small light assembly body when turned on.

### DETAILED DESCRIPTION OF DRAWINGS

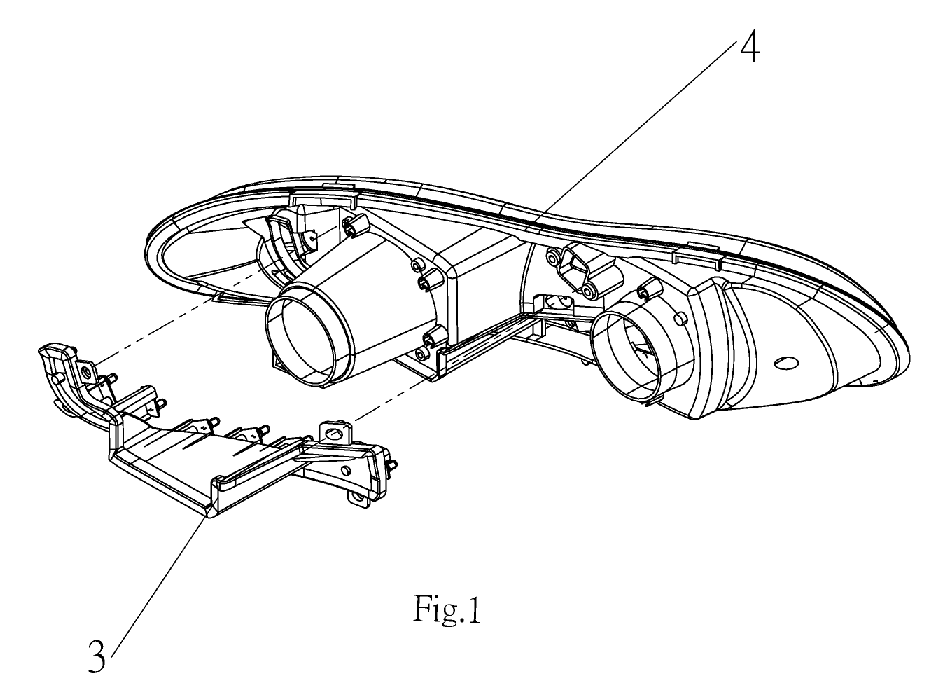

Referring to FIG. 1 an 5, a vehicle auxiliary light with Lined-Up LED's includes a big light assembly 4 and a small light assembly 3 which includes a plurality of seriously connected LED's 2, and a small light assembly seat 1.

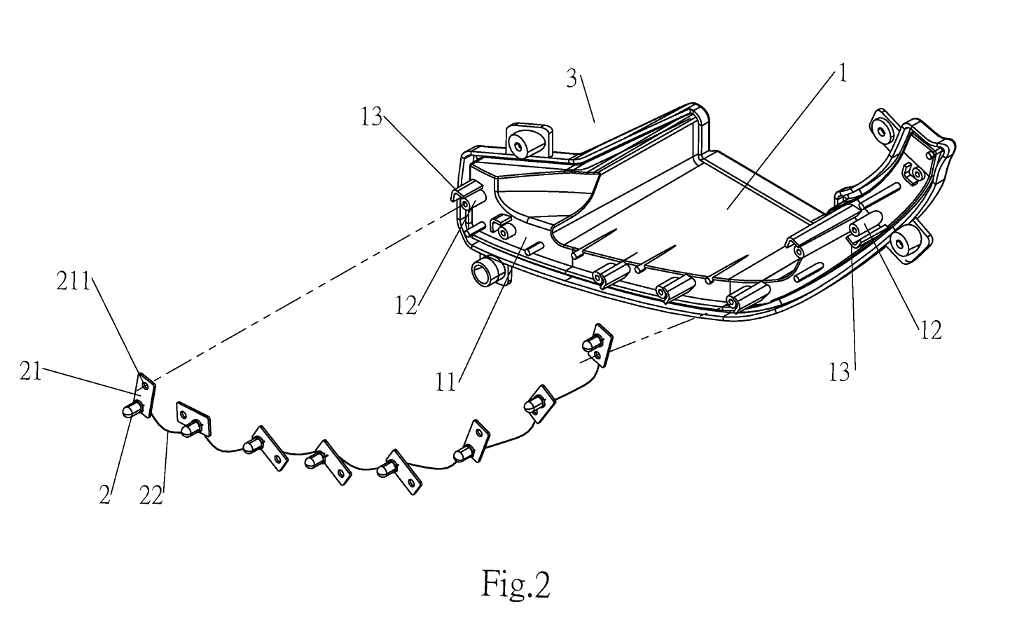

The small light assembly seat 1 further includes a horizontal supporting piece 11 extending from one side of the small light assembly seat 1, as shown in FIG. 2, a plurality of hollow cylinders, and a L-shape defender 13 extending vertically downwards from one side of each of hollow cylinders 12.

A plurality of LED's 2 are connected in series by electric wires 22. The actual number of LED's 2 is determined by the number of hollow cylinders and the distance between each of hollow cylinders. Each LED is secured to a fixing board 21 which includes a through-hole 211 that corresponds to a hollow cylinder 12 of the small light seat 1.

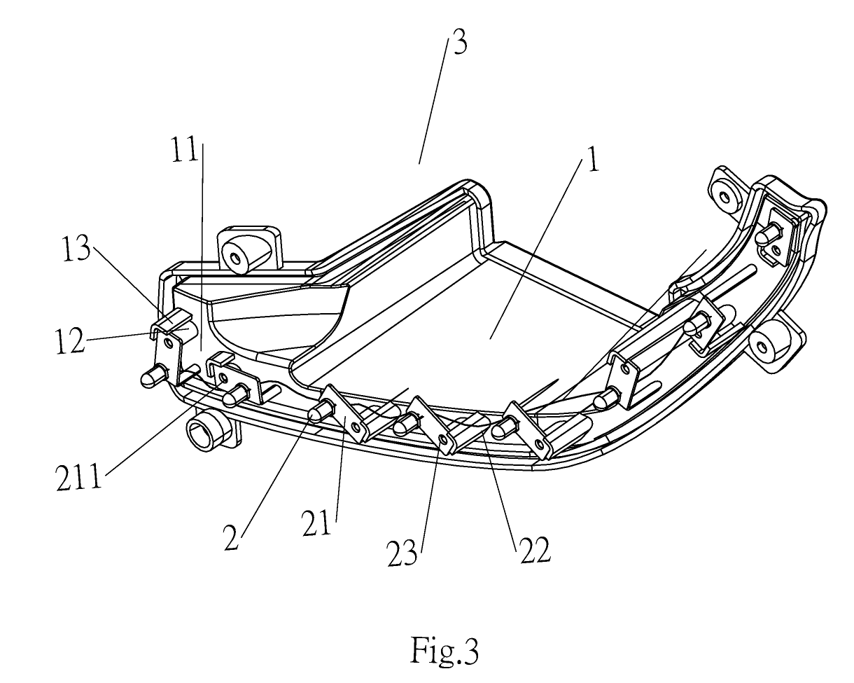

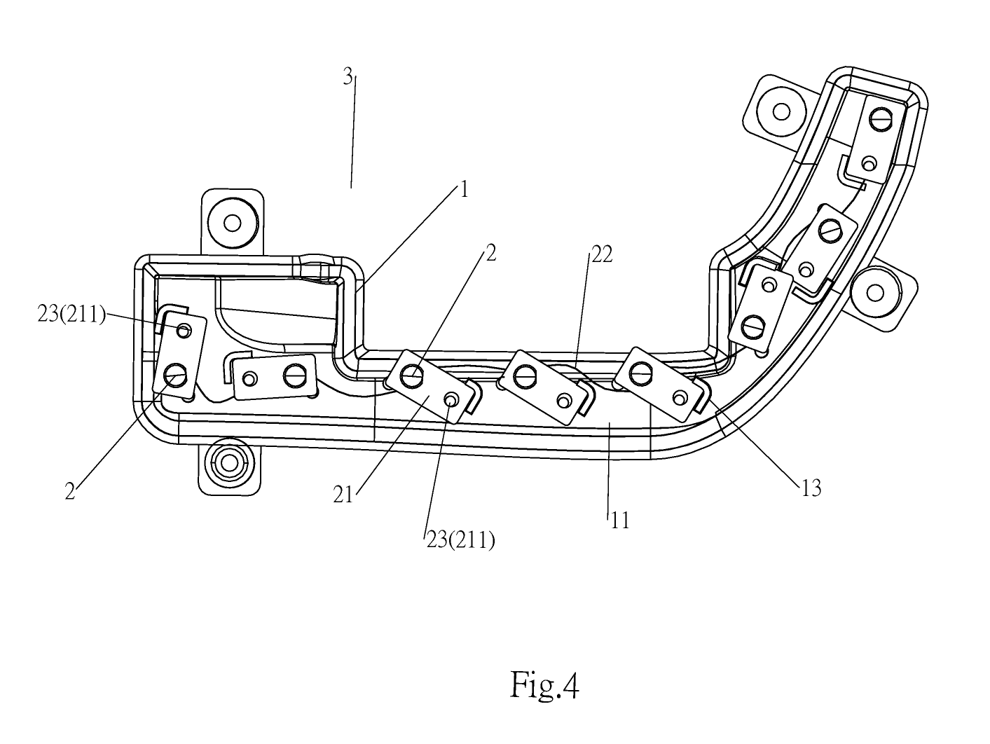

Please refer to FIG. 3 and 4 for assembling the seriously connected LED's 2. Each fixing board 21 with an LED disposed thereon is secured onto its corresponding hollow cylinder of the small light seat 1. In addition, a corner of the fixing board 21 is always located under the L-shape defender 13. A screwing element 23 fixes each fixing board 21 to a corresponding hollow cylinder of the small light assembly seat 1 to forma a small light assembly 3, as shown in FIG. 3.

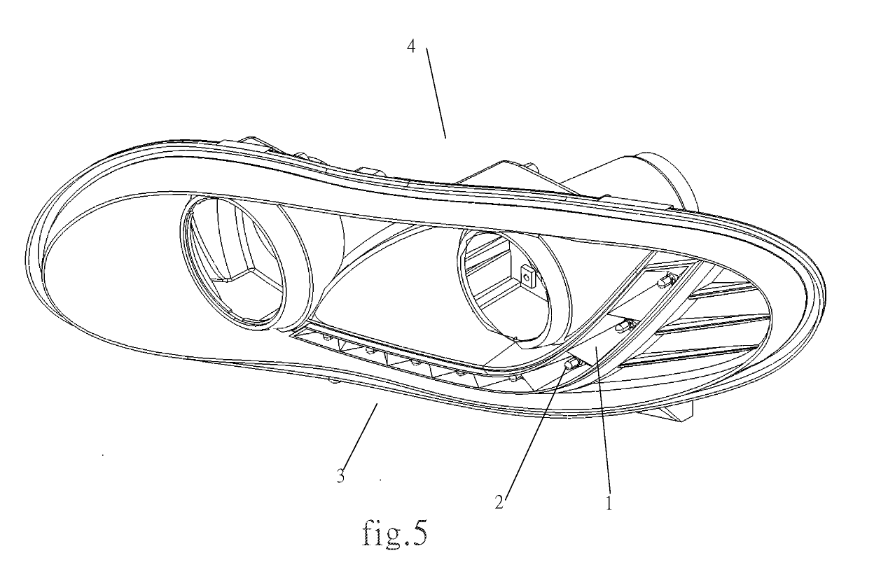

Please refer to FIG. 5 for assembling a small light assembly body 3 with the big light assembly 4. In assembly, The a small light assembly 3 is snap into its corresponding big light assembly 4 at the rear part thereof, which is reserved for the small light assembly 3.

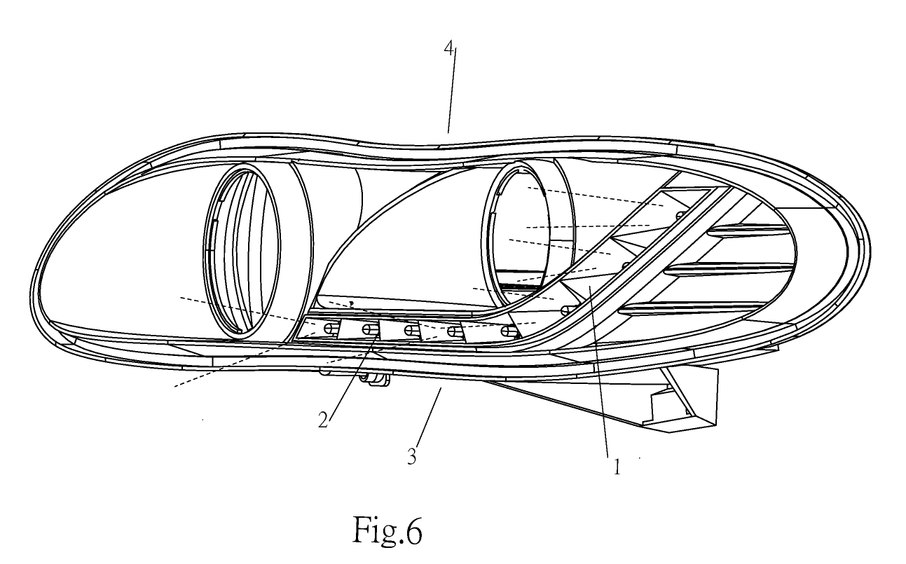

As a result, the small light assembly 3 is disposed beneath and closer to the periphery the big light assembly 4 thereof. Therefore, when a driver turns on the small light assembly 3 and the big light assembly 4 at night or in days of dim light, brighter light is provided due to contribution from the LED's of the small light assembly 3 which are lined up in an L-shape, as FIG. 6 shows. In other words, the L-shape LED's serve as auxiliary lights for the big light assembly 4.

Advantages associated with the above described invention include:
1. easy maintenance: when replacing a single LCD in small light assembly body, a user only needs to take out that specific small light seat located at the rear of the big light assembly body and replace the broken one with a good LCD.
2. LCD's in the small light assembly body line up in an L-shape to add brightness to the big light assembly body.
3. The small light assembly body made up of LCD's work in accordance with the big light assembly body even during daytime.

1. An auxiliary light assembly with lined-up LCD's, located at the rear of the vehicle main light assembly, comprising
a light seat for a plurality of LCD's; and
a horizontal supporting piece, extending from one side of said light seat, further comprising
a plurality of hollow cylinders, and
a plurality of fixing boards, each of which secured with an LCD and
fixed to said horizontal supporting piece by screwing elements.

2. The auxiliary light assembly with lined-up LCD's as claimed in claim 1,
wherein said horizontal supporting piece further comprises a plurality of defenders, each of which extends vertically downwards along one side of said hollow cylinders to partially confine said fixing board.

3. The auxiliary light assembly with lined-up LCD's as claimed in claim 1, wherein each of said plurality of LCD's is connected in series by electric wires.
